(19) United States
(12) Patent Application Publication
(10) Pub. No.: US 2006/0219801 A1
(43) Pub. Date: Oct. 5, 2006

(54) Arc wire burner

(75) Inventors: Tilmann Haug, Weissenhorn (DE); Sven Schach, Erbach (DE); Torsten Wittrowski, Ulm (DE)

Correspondence Address: AKERMAN SENTERFITT, P.O. BOX 3188, WEST PALM BEACH, FL, 33402-3188, US

(73) Assignee: DaimlerChrysler AG, Stuttgart (DE)

(21) Appl. No.: 11/378,605

(22) Filed: Mar. 17, 2006

(30) Foreign Application Priority Data
Mar. 17, 2005 (DE) 102005012360.0-51

(51) Int. Cl. B05B 1/24

(52) U.S. Cl. 239/84; 239/79; 239/83

(57) ABSTRACT

An arc wire burner for arc wire spraying with at least two burner tubes for supplying electrodes in the form of wire, which are guided and advanced through the burner tubes in the direction of the surface of the object to be coated, wherein the wire is guided along a deflection device including a rotatable mounted guide and/or slide element (8), by means of which the wire is deformed in the elastic realm.

### CROSS REFERENCE TO RELATED APPLICATION

This application claims the benefit of German Application No. DE 10 2005 012 360.0-51 filed Mar. 17, 2005.

### BACKGROUND OF THE INVENTION

1. Field of the Invention

The invention concerns an arc wire burner for electric arc spraying with at least two burner tubes for feeding electrodes in the form of wires, which are guided towards the surface of the object to be coated by a deflection device comprising a number of rotationally mounted guiding and/or slide elements.

2. Description of Related Art

An apparatus for thermally coating the inner walls of hollow spaces such as the inner walls of cylinder surfaces is already known from DE 198 41 617 A1. The apparatus includes two burner tubes provided for feeding wire electrodes. The electrodes are melted by an electric arc. The apparatus further includes a gas supply for a process gas, which is used to atomize and transport the molten wire material in the direction of the surface of the hollow space to be coated. Electrodes or the wires are guided out of the outlets of the burner tubes and towards each other in the vicinity of the electric arc, wherein the electric arc of the electrode wires, in the contact area of the wires, is in the vicinity of the gas stream of the streaming process gas. The stream of gas of the emitted process gas, referred to in the following for simplification as the main gas flow direction, is transverse to the main transport direction of the wires, which is determined by the burner tubes. Layers which are sprayed with this type of interior-space burner on a particular metallic substrate, preferably an engine cylinder running surface, in general exhibit a high porosity.

A welding burner with a supply device for electrodes in the form of wire is known from JP-11 342471, which wires are advanced in the direction of the surface of an object to be coated through the burner tube via rotatably mounted rollers, wherein the supply device is provided outside of the welding burner.

From DE 102 43 739 B3 an arc wire burner is known, which includes at least two burner tubes for supplying electrodes in the form of wires, which are advanced through the burner tubes in the direction of the surface of an object to be coated via a number of rotatable mounted guide and/or slide elements of the deflecting supply guiding device, wherein the supply guide device equipped with the guide and/or slide elements, by means of which the wire is deformed in the elastic or plastic range, is integrated in or is received the burner tube, and wherein the slide elements are in the form of rollers or ball bearing mounted rollers.

### SUMMARY OF THE INVENTION

The invention is concerned with the task of redesigning the wire supply in the arc wire burner in such a manner that the wire is easily inserted, and is guided or supplied as precisely and as friction-free as possible until the short circuit point of the arc wire burner.

This task is inventively solved thereby, that on the outer curvature or side of the wire deflection device the guide and/or slide elements are provided respectively in the form of ceramic slide tracks (bars, rails), and on the inner curvature or side as respectively at least one roller, which are arranged in such a manner, that they form a guide track for receiving the wire.

A design of this type has the advantage that it is easier to introduce or thread-in the wire into the direction changing device than in the design according to DE 102 43 739 B3, in which the wire easily jams or gets caught in the intermediate space between the rollers on the deflection outer curvature or side.

In comparison to a design in which rollers are completely dispensed with, the wire friction wear is significantly reduced and thus the maintenance rate or service interval of the arc wire burner can be substantially improved.

Essential for an enduring functionality of the brittle ceramic slide tracks is the avoidance of pulling and/or bending loads. Thus a continuous exact positioning on its support plate is necessary.

This can occur by pressing in ceramic slide tracks or bars in a ceramic support plate. For this, a precise manufacturing of both parts is necessary.

An alternative is by the fixing of the ceramic slide bars in the ceramic support plate by means of fixing screws. This simplifies the positioning and the change-out. The screws require supplemental space.

In an advantageous embodiment the ceramic slide bars are adhered in a ceramic support plate, preferably are glued in on their side surfaces.

For this, a ceramic receptacle is prepared designed in such a manner that upon insertion of the ceramic slide tracks on both sides a gap is formed, which can be filled with adhesive. This lowers the demand on manufacturing precision. Abutment or contact surfaces can be used to maintain positioning precision. During installation of the ceramic slide bars no mechanical loads occur. In the case of use of releasable adhesives, for example melting adhesives, a change-out of the ceramic slide bars is possible.

Instead of adhering the ceramic slide bars on their sides, they can also be adhered on their outer surface. In this case however a precise positioning relative to the cooperating rollers is more complex.

In place of a two-piece design with ceramic slide tracks and receptacle, it is also possible to produce the lower part of the direction changing device as a single piece of ceramic.

In order to impart on the wire a defined deflection or direction changing radius, a precise positioning of the rollers relative to the ceramic slide track is necessary. At the same time the space available for receiving the rollers, ceramic slide tracks and their receptacles is very limited.

This problem is most easily overcome when the ceramic receptacle and a roller receptacle for at least one roller are produced as a single piece. Beyond this, one dispenses with the possibly complex precise positioning of two individual receptacles.

Further construction space can be saved when the at least one roller is mounted on only one side. In comparison thereto a two-sided mounted roller is stronger and can accept a load for longer periods.

Finally, according to a preferred embodiment of the inventive solution it is proposed that the at least one roller includes a guide groove provided concentric to the axis for guiding the wire.

Further, it is of advantage when, subsequent to the at least one roller, a sliding contact is provided, which by means of a spring is held against the surface of the wire.

By the use of a sliding contact subsequent to the direction change, the supply of current to the wire is maintained in optimal manner. If the supply of current occurs prior to the direction change, then the section until the contact point is too long and the wire heats up in this section so strongly that damage can occur to the guidance and/or slide elements due to the thermal loads.

Advantageously the outer surface of the sliding contact facing the wire is adapted to the contour of the curved wire, in order to ensure optimal contact. The wire entry or threading-in area of the sliding contact is somewhat widened, in order to facilitate insertion.

The sliding contact can be held pressed linearly upon the wire in simple manner by means of a press-spring. Better yet is to provide the slide contact so that it is also pivotable, since this would also facilitate the introduction of the wire.

Besides this it is advantageous when the direction changing supply device of the wire includes an adjustment device, by means of which the position of the wire exit can be adjusted relative to a nozzle head of the arc wire burner.

This makes it possible to compensate for minimal position deviations of the wire exit attributable to plastic deformation of the wire. This compensation occurs at least within the plane of curvature of the wire, preferably however also perpendicularly thereto.

One such adjustment device is conveniently provided in the form of adjustment screws. Even more simple solutions are provided by elongate holes for the holding of the rollers, and ceramic receptacles, or even spacer discs.

### BRIEF DESCRIPTION OF THE DRAWINGS

Further advantages and details of the invention are set forth in the patent claims and the description and shown in the figures. There is shown:

FIG. 1 A prospective view of an arc wire burner;

FIG. 2 A first illustrative embodiment of a deflecting supply device with direction changing rollers arranged in series and with a ceramic slide track working in cooperation therewith;

FIG. 3 A second illustrative embodiment of the deflection device with a single large direction changing roller and with a ceramic guide track working in cooperation therewith;

FIG. 4 A one-piece receptacle for ceramic guide track and roller; and

FIG. 5 A sliding contact for energy (current) transmission.

The figures are schematic and not true to scale.

### DETAILED DESCRIPTION OF THE INVENTION

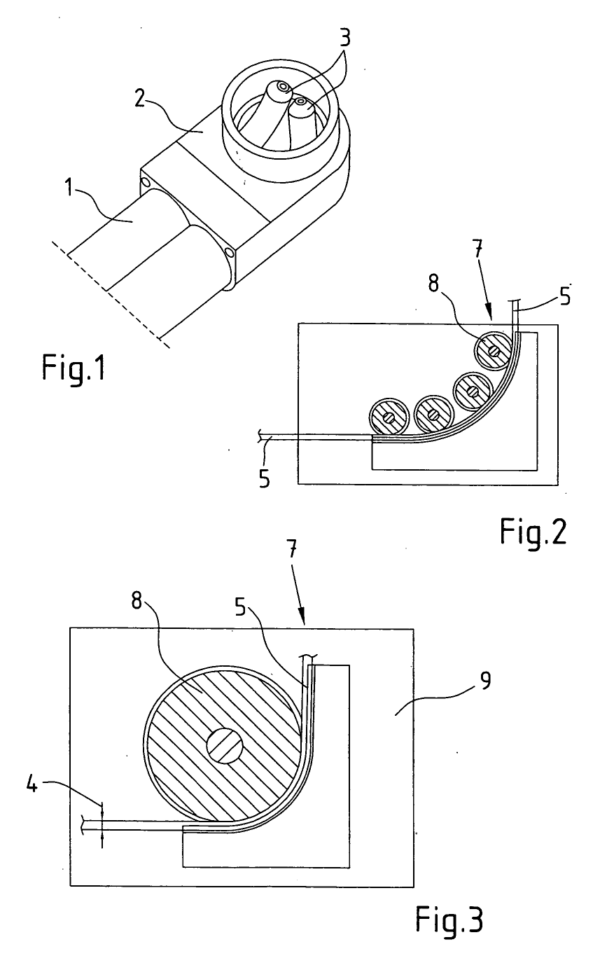

In FIG. 1 a supply tube 1 for an arc wire burner is shown, which can be employed in particular for arc wire spraying of hollow spaces, in particular running surfaces of engine cylinders.

The interior burner includes for this a nozzle head 2, which is connected to the burner tube 3. On the outlet opening of the nozzle head 2 there are the two burner tubes 3 for supplying of electrodes, which are in the form of wires 5. The wires 5 are provided for being melted by an electric arc. The droplets formed from the molten wires 5 are atomized and transported by a process gas in the direction of the surface of the hollow space to be coated.

So that the electric arc can form between the ends of the wires 5, the two wires 5 are fed towards each other subsequent to the outlet side of the burner tube. The supplying of the wires occurs by a supply device or, as the case may, be deflection device 7, which can be seen schematically in the two illustrative embodiments according to FIGS. 2 and 3.

The supply or, as the case may be, deflection device 7 is comprised of two (not shown in the figure) spaced apart from each other arranged and parallel running plates, which are held together via connecting elements (likewise not shown in the figures).

The deflection device 7 includes four sequentially arranged rollers 8, which are provided in the roller receptacles. The individual deflection rollers 8 are mounted to be freely rotatable by means of roller-bearing mounted axles not shown in the figures.

As can be seen from FIG. 2, the series of the guide rollers 8 runs along an arc. The individual guide rollers 8 are provided in close tolerance to a ceramic slide track 9 and are in working cooperation therewith. The distance between the outer circumference of the guide rollers 8 and the ceramic slide track 9 is the same as or slightly greater than the outer diameter of the wire 5. The individual guide rollers 8 and the ceramic guide tracks 9 working in cooperation therewith form, by their spacing from each other, a guide path, through which the wire 5 is moved.

As can be seen from FIG. 2 or as the case may be FIG. 3, the wire 5 can be deformed in the elastic or even the plastic realm. By the deflection of the wire 5 by means of the contact guiding deflection rollers 8, as already described, which are provided in advantageous manner in roller bearings not shown in the figures, the friction forces due to the plastic or elastic deformation of the wire 5 are kept small. Since multiple different deflection rollers 8 and 9 are provided sequentially provided upon roller bearings, the wire 5 is guided precisely until the short-circuit point of the electric arc wire burner. By the employment of miniature ball bearings the construction space for the total device can be kept small or, as the case may be, substantially reduced, and besides this the longevity of the device can be extended. At the same time, by the advantageous provision of the deflection rollers 8 and their design, the service intervals of the arc wire burner can be extended.

As likewise seen from FIG. 2, the guide and/or slide elements on the outer side or outer circumference of the wire deflection device are ceramic guide tracks 9 and on the inner side are rollers 8.

A design of this type has the advantage that the wire 5 is easier to introduce or thread into the deflection device 7 than in the case of an embodiment with rollers on both sides, in which case the wire on the deflection outer side (outer curvature) can easily get jammed in the intermediate space between the rollers.

The ceramic guide track 9 is adhered on its side surfaces in a ceramic receptacle 91, which is designed to be approximately 0.2 mm wider than the ceramic guide track 9. Accordingly adhesive can be introduced into the gap formed on both sides of the ceramic guide track 9 for securing the ceramic guide track 9 in the ceramic receptacle 91.

The ceramic receptacle 91 is designed with such a depth, that after introduction of the ceramic guide track 9 a guide groove remains, in which the wire 5 can be guided.

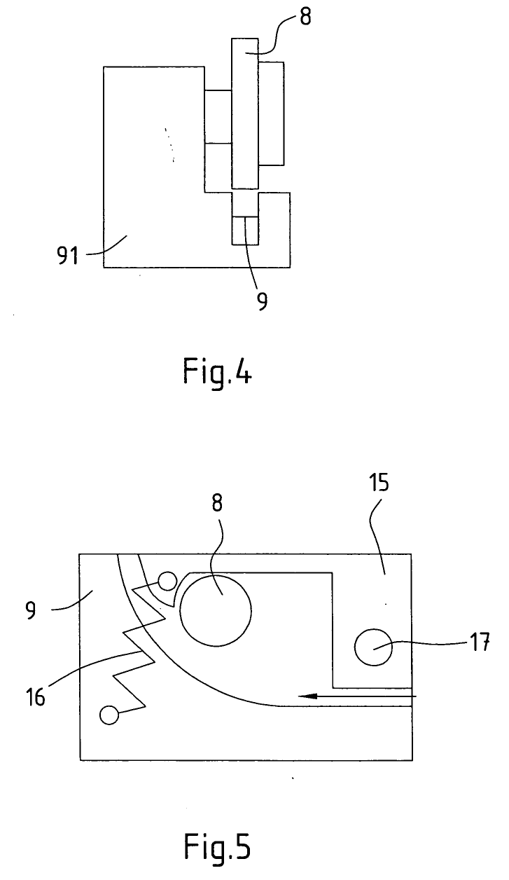

The ceramic receptacle 91 is one piece with the receptacle for the rollers 8, as can be seen from FIG. 4.

In advantageous manner the individual deflection rollers 8 can likewise be provided with a guide groove running concentric to the axis of rotation, along which the wire 5 is conveyed. Both guide grooves (on rollers and ceramic guide tracks) form a wire guide, of which the diameter is slightly larger than the outer diameter of the wire 5.

In FIG. 3 a second illustrative embodiment is shown for the supply device or as the case may be deflection device 7. This is comprised likewise of two plates arranged spaced apart from each other for receiving the axle for a deflection roller 8 which, in cross section, is substantially larger.

The deflection device 7 can, in accordance with FIG. 5, also be provided with a sliding contact 15, which was provided subsequent to the deflection. By means of the slide contact 15 a sufficient power transmission or, as the case may be, current supply for the wire 5 can be ensured.

The slide contact 15 is pulled against the wire 5 via a pull spring 16 and is mounted above the slide track to be pivotable about a rotation point 17 ahead of the roller 8. The pivotable mounting simplifies the threading-in of the wire 5, since the slide contact 15 can be pivoted out of its rest position by slight contact upon the wire 5 without impeding the advancing of the wire 5.

Preferably the outer surface of the slide contact 15 facing the wire 5 is adapted to the contour of the curved wire 5, in order to ensure optimal contact. The wire insertion area of the slide contact 15 is somewhat widened, in order to simplify the insertion or threading in of the wire.

### REFERENCE NUMBER LIST

1. Supply tube for an arc wire burner or burner
2. Nozzle head
3. Burner tube
5. Wire, electrode
7. Supply device or deflection device
8. Guide and/or slide element, roller
9. Guide and/or slide element, ceramic guide track
91. Ceramic contact receptacle
15. Slide contact
16. Spring
17. Rotation point of the slide contact

1. An arc wire burner for electric arc wire sprayer with at least one burner tube (3) for supplying electrodes in the form of wire (5), which are advanced in the direction of the surface of an object to be coated through the burner tube (3) via a deflecting supply device (7) including rotatably mounted guide and/or slide elements (8, 9), wherein the supply device (7) having the guide and/or slide elements (8, 9), by means of which the wire (5) is elastically or plastically deformed, is integrated or received in the burner tube (3), wherein the guide and/or slide elements (8, 9) are, respectively, ceramic slide tracks (9) on the outer curvature of the wire deflection and at least one roller (8) on the inner side of the curvature of deflection, which are provided in such a manner that they form a guide path for receiving the wire (5).

2. An arc wire burner according to claim 1, wherein the ceramic guide tracks (9) have side surfaces and are adhered in a ceramic receptacle (91), on their side surfaces, or are pressed in or screwed in.

3. An arc wire burner according to claim 2, wherein the ceramic receptacle (91) and the roller receptacle (81) for the at least one roller (8) are formed as one piece.

4. An arc wire burner according to claim 1, wherein at least one roller (8) is mounted on only one side.

5. An arc wire burner according to claim 1, wherein thereby characterized, that the at least one roller (8) includes a guide groove (14) provided concentric to its axis for guiding the wire (5).

6. An arc wire burner according to claim 1, wherein after the at least one roller (8) in the direction of advance of the wire a slide contact (15) is provided, which is held against the surface of the wire (5) by means of a spring (16).

7. An arc wire burner according to claim 1, wherein the deflecting supply device (7) of the wire (5) includes an adjustment device, by means of which the position of the wire exit relative to the nozzle head of the arc wire burner is adjustable.
